(19) United States
(12) Patent Application Publication
(10) Pub. No.: US 2009/0076959 A1
(43) Pub. Date: Mar. 19, 2009

(54) SYSTEM AND METHOD FOR BROKERING AD HOC PERSONAL IDENTIFICATION TRANSACTIONS BETWEEN TWO CONSENTING PARTIES

(76) Inventor: Patrick Devaney, San Diego, CA (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/208,984

(22) Filed: Sep. 11, 2008

Related U.S. Application Data
(60) Provisional application No. 60/971,471, filed on Sep. 11, 2007.
(60) Provisional application No. 60/971,491, filed on Sep. 11, 2007.

(51) Int. Cl. G06Q 20/00

(52) U.S. Cl. 705/44

(57) ABSTRACT

Disclosed is a computer-based system and method for conducting ad hoc personal identification, or ID, transactions between at least two or more persons by means of a personal identification transaction apparatus attached to at least two communications channels. The personal identification transaction apparatus is intended to assist the interaction between two persons by brokering an identification transaction thus alleviating the exchange of detailed information necessary to confirm an identity, particularly that portion of a person's identity that is related to the purpose of the interaction between two persons. A component of the personal identification transaction apparatus includes a identification transaction order generation unit that provides a score associated with each user party to the transaction, as well as the transaction itself.

The present application claims priority to U.S. Provisional Patent Application No. 60/971,491 filed Sep. 11, 2007.

### CROSS-REFERENCE TO RELATED APPLICATIONS

This application is related to the following U.S. Applications, all of which are incorporated by reference herein:

U.S. application Ser. No. ______, entitled “A System and Method for Actively Maintaining a Personal Identification Profile For Use in a Personal Identification Transaction” filed concurrently herewith, by Patrick Devaney and David Thatcher, attorney docket number ______.

U.S. application Ser. No. ______, entitled “A System and Method for Scoring a Personal Identification Profile For Use in a Personal Identification Transaction” filed concurrently herewith, by Patrick Devaney and David Thatcher, attorney docket number

### BACKGROUND OF THE INVENTION

1. Field of Invention

The present invention relates to a computer-based system and method for conducting ad hoc personal identification, or ID, transactions between at least two or more persons, although it is intended that a machine or business under the control of a person may be additional counter-parties in subsequent embodiments.

2. Description of the Related Art

It is generally acknowledged by those skilled in the art that the verification of ones identification forms the genesis of a transaction for goods, services and the transfer of information between two or more parties. A plethora of patents and generally accepted schemas exist to safeguard, retrieve, authenticate and deliver personal information pertaining to a single party in a transaction. There also exists a plethora of patents that rely on an identity authentication schema derived at the request of a single entity or single user on a system, utilizing information that is pulled onto the system from third-party information sources of both pubic and private nature. Often, these schemas occur without the express consent or knowledge of the counter party or subject of the transaction. What is currently needed is a method to enable and broker each party to a transaction to proactively and efficiently establish their separate identity on a system, and execute a consented, dedicated identification transaction as a precursor to a contemplated transfer of goods, services or information.

### SUMMARY OF THE INVENTION

The ad hoc ID transaction (FIG. 1) consisting of a authentication of and request by user A to initiate an ID transaction with a second user B . . . n on the system. After all users party to the contemplated ID transaction are authenticated on the system, the system generates an ID transaction order including a series of system prompts for selection of entity, attributes, relationships and role data by user A from a menu of common codes and input data fields that correspond to the contemplated ID transaction. For example, a doctor visit, location and name of provider; or building access, building address and appointment time block; or medical record, and document type. The system then generates at least three identifier parts associated with the subject ID transaction order. Part 1 is retained on the system and attached to the ID transaction stored on the system. Parts 2 and 3, are transmitted separately via user directed communications channels to each party, to be used one time only at the time of completion of the ID transaction. It is envisioned that subsequent embodiments may include more than two parties to an ID transaction, and these parties would receive subsequent identifiers in series beyond Part 3. At the time of the intended identification exchange, the subject ID transaction is recalled by user A, or at least one of the subject user's who are party to the ID transaction, via a single communications channel in the preferred embodiment. A system prompt is generated by means of a GUI, voice or text communications, for each user to input their unique transaction identifier via machine generated text, voice generated text, voice, or biometric input such as a fingerprint. An authentication method on the system matches the Part 1 identifier maintained on the system, to Part 2 through 3˜n. Once all parts have been authenticated, the system generates a closing procedure to the ID transaction, and a receipt which is stored on the system with copies transmitted to each user's intended repository. In the preferred embodiment, the system and method is intended to protect users, at a single point in time and in the presence of each other, against fraud and mistakes associated with interaction between individuals from whom identity information is difficult to obtain, verify, or that is not practical to transport and convey. The system is also intended to assist individuals who desire to avoid the unwanted dissemination and thus unintended repositories of their personal information, depth and context of which is essential to effectively authenticate an identity.

### BRIEF DESCRIPTION OF THE DRAWINGS

FIG. 1 is an illustration of a flow chart of a method that could be used to implement the initiation of a personal identification transaction according to the present invention;

FIG. 1A is an illustration of a flow chart of a method that could be used to implement a closing procedure to an open personal identification transaction according to the present invention;

FIG. 2 is a diagram illustrating a personal identification brokering transaction being performed by a personal identification brokering apparatus according to the present invention;

FIG. 3 is a diagram illustrating a new user being acquired onto the system utilizing a new user acquisition apparatus according to the present invention;

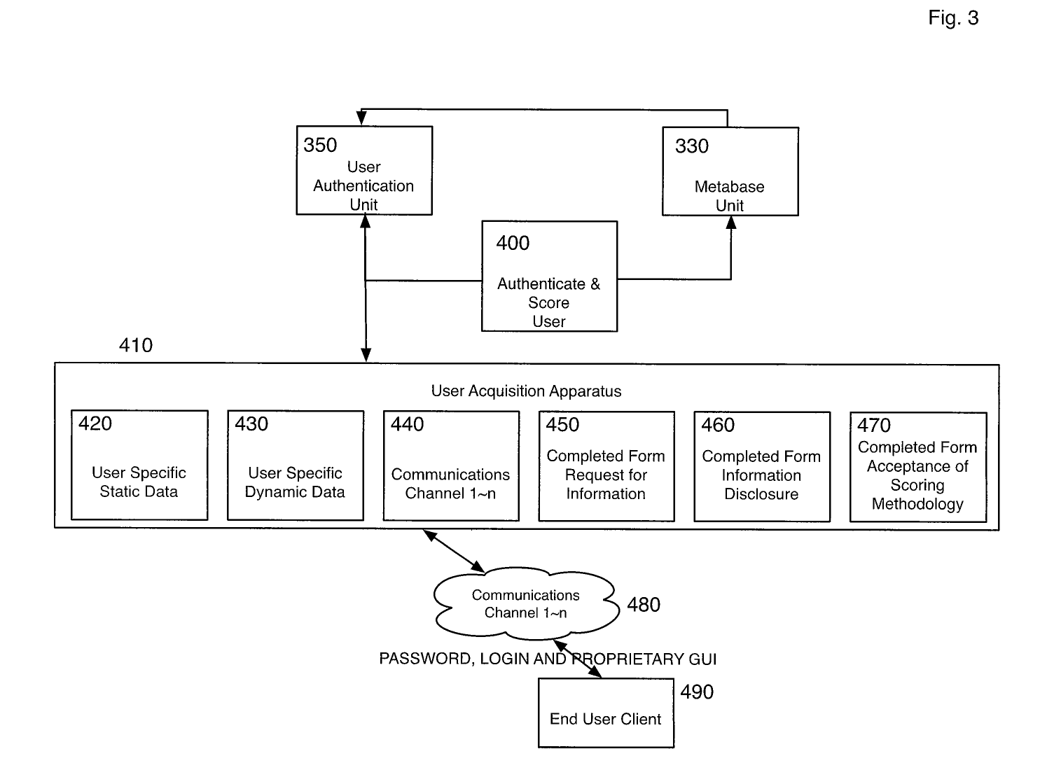

FIG. 4 is a diagram illustrating the system generation of a personal identification order transaction between at least two users utilizing a personal identification order generation apparatus according to the present invention;

FIG. 4A is an illustration of a semantic relationship data schema.

### DETAILED DESCRIPTION OF THE INVENTION

A preferred embodiment is now described in detail. Referring to the drawings, like numbers indicate like parts throughout the views. As used in the description herein and throughout the claims and drawings that follow, the meaning of “ID” refers to identification.

The exchange of identity between two persons is increasingly important in the course of everyday life owing to evolving trends toward the business practice of outsourcing, in-home medical therapy, identity theft, medical identity theft, and a plethora of undocumented workers living among the greater population. In the context of this patent, an identity includes the positive verification of “who” a person as well as “what” their associated attributes are that relate to the ad hoc nature of the interaction between two persons. For example, “mary” may present a valid driver's or employee identification card to “bob” to prove she is, in fact, “mary”, but “bob” may not be an authority on driver's licenses or employee identification documents, nor well versed in the subtleties of detecting a fraud. More importantly, the interaction between “mary” and “bob” has to do with a in-home physical therapy session to with “bob” is also concerned that “mary” is dually licensed to perform such a procedure as well as a valid employee of “xyz physical therapy” company. It is well known among those skilled in the art that increased amounts of precise and time-relative information that can be accumulated on a person, corresponds to the higher the probability that the identity of a person can be confirmed. Much of this detailed data is protected by privacy laws, and requires consent of the individual that owns or is the subject of the data. And, certain aspects of increased levels of data and detail necessary to confirm a person's identity within the context of the present invention, has little or no relation to the purpose of the interaction between two persons, particularly if there is not a financial transaction being conducted at the time of the interaction. Moreover, it is not always practical to carry all of the documentation required to confirm ones identity to remote locations in order to interact with another person for the exchange of goods, services or information. Because of this, people everyday must rely on good faith when transacting with a second party even when the top-level aspect of “who” the second party is not in question.

The present invention is intended to assist the interaction between two persons by brokering an identification transaction thus alleviating the exchange of detailed information necessary to confirm an identity, particularly that portion of a person's identity that is related to the purpose of the interaction between two persons. A secondary embodiment of the present invention is intended to provide an audit function for the delivery of goods, services or information. For example, a caregiver that is governed by a license, or has a documented skill set sought by a patient who interacts with the patient at a remote location or in the home. The present invention is intended to be used in conjunction with Government issued forms of identification that is static, brief or focused by design, and yet itself vulnerable to fraud and criminal manipulation.

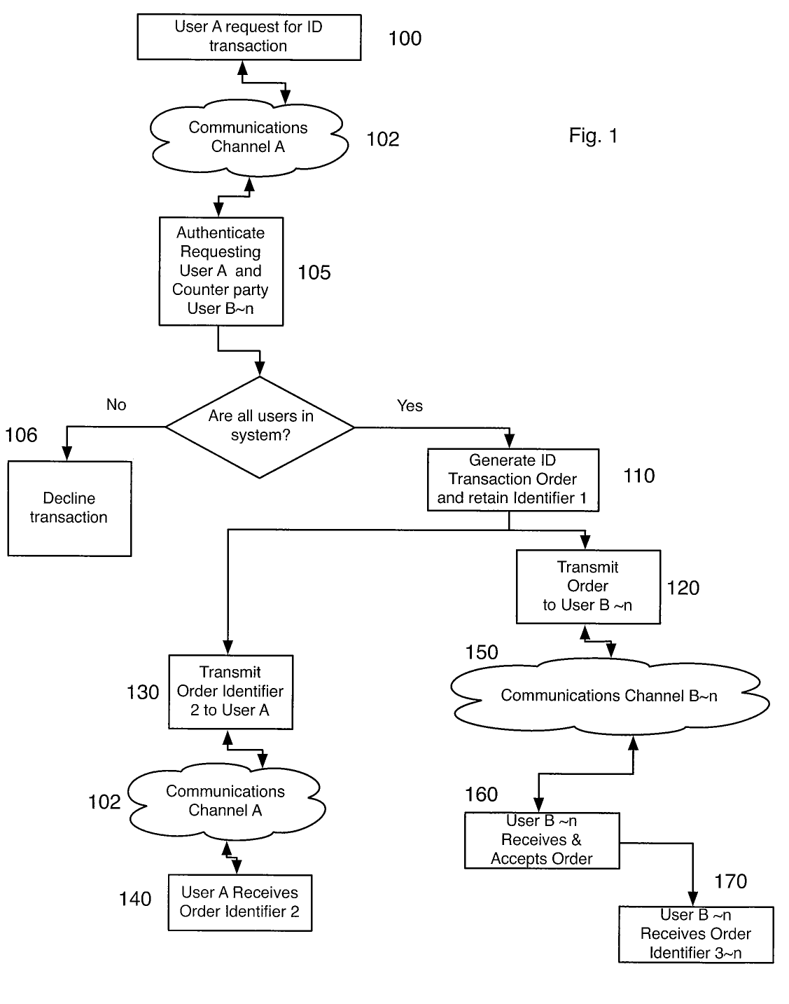

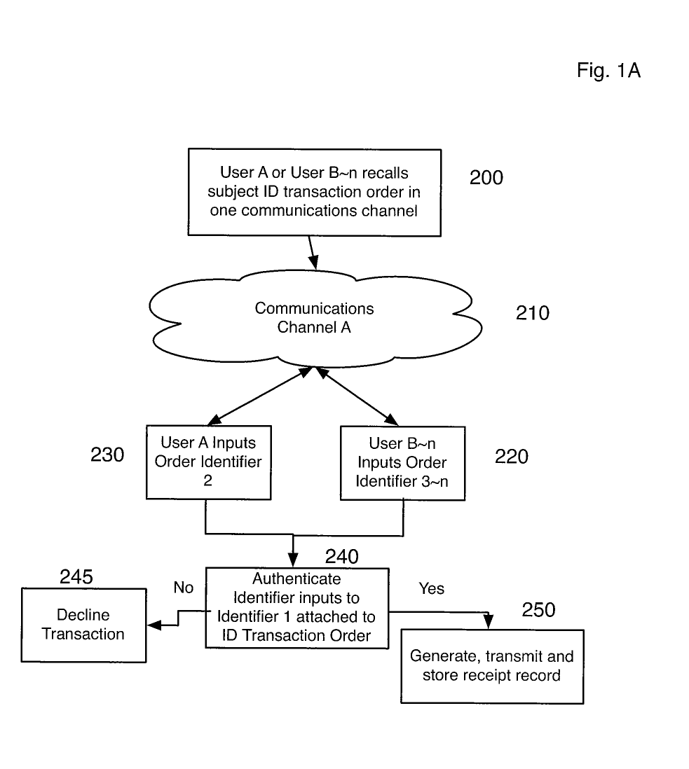

In FIG. 1, user A initiates a request to enter into an ID transaction with user B˜n via a communications channel 102 connected to a module on the system 105 contained in the order generation unit 340. Both parties to the transaction must be known on the system in order to proceed with the generation of an ID transaction order 110. At least two portions of the order are communicated 120/130 to the requesting user 100/140 and the counter party user B˜n 160. Communication with the counter party is by means of a secondary communications channel 150, and whom receives first an order request 160 that must be acknowledged and returned before the order can proceed whereby user B˜n subsequently receives their unique order identifier 170.

In FIG. 1A, at a single point in time when the interaction between the user's party to the transaction is intended to take place, the order is recalled on the system by one of the users 200 in a communications channel 210, whereby both users input their unique order identifier 230/240 received in advance. The identifier's are authenticated on the system 240 and creates a record and receipt 250 for the transaction and closes the order and transaction forever.

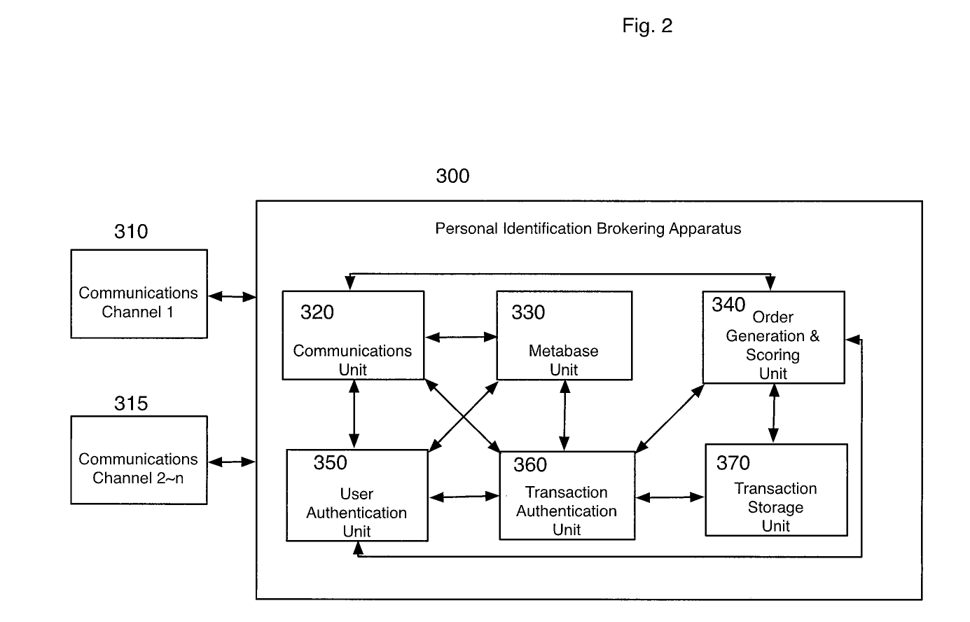

FIG. 2 illustrates a personal identification brokering apparatus 300 with at least two communications channels 310/315 connected to the system. A user authentication unit 350 acquires or updates users onto the system, and communicates with a communications unit 320, a data storage unit 330, a transaction authentication unit 360 and the order generation unit 340. ID transaction orders generated on the system 340 include a score for the users and the transaction, which are subsequently stored 370.

Users submit data that is authenticated 400 and stored by a metabase unit 330. The primary communication interface with a user 490 is the Internet 480 with additional communications channels such as a telephone, facsimile, or postal service to communicate certain aspects of a person's data being submitted to the user acquisition apparatus 410. Users submit data at their discretion, including static data 420 such as driver's license, passport, vehicle type, and address; dynamic data 430 such as customer loyalty card transactions, health record data, frequent flyer activity, and credit card transactions; and the manner in which they would like to communicate with the system 440 such as telephone, personal communications device, or email. For certain types of information pertaining to unique purposes that a user intends to use the system to conduct ID transactions, a user will also execute and submit a request for information form 450 and an information disclosure form 460. Users also adhere to the scoring methodology by completing a form 470 that binds them to any and all ID transactions they enter into on the system.

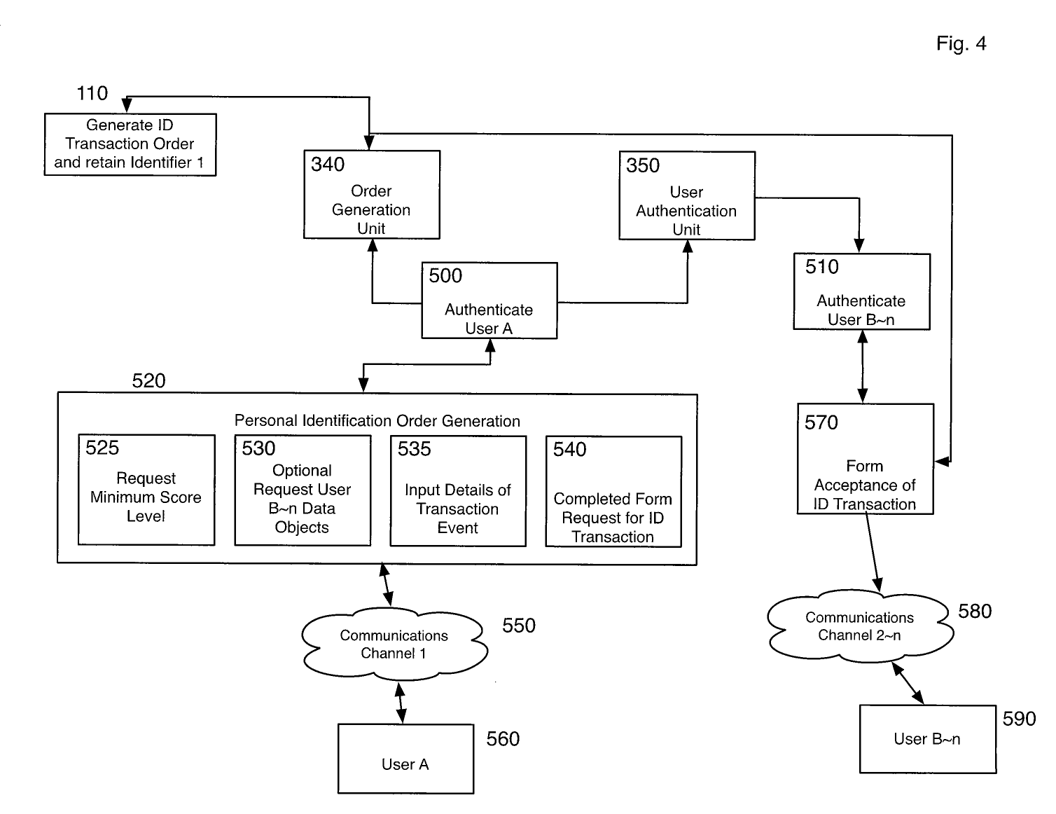

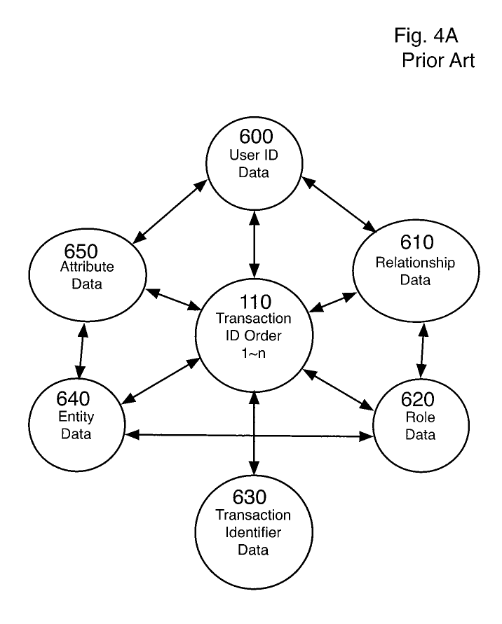

FIG. 4 details the specifics of an ID transaction order request. At the point in time when a user intends to initiate an order 110, a user 560 communicates with the system 550 and the personal identification order generator module 520. A user selects a minimum score level sought 525 for the ID transaction, any additional information pertinent to the specific ID transaction 530 and the details of the ID transaction 535 including who the counter parties are. Additional information and specific data object's 530 that can be ordered by the initiator of the ID transaction are intended to focus the transaction on an intended purpose. For example, a patient user may want to ensure that a physical therapist has a current license and is employed by or has a current employment or contract relationship with a specific medical institution prior to initiating an in-home therapy session. Or, a homeowner may seek to ensure that a local contractor has a valid construction license, insurance bond, and who's worker whom is the person entering into the ID transaction is a legal US citizen before the homeowner allows that person to begin work on a home project. In this example, the counter value of the ID transaction is held by the local contractor, whereby the ID transaction documents intent by the homeowner to acquire the services of the contractor, and the contractor's employee was at least in the presence of the homeowner on a specific day and time. The order request 540 is not complete until user A is authenticated on the system 500, as well as the counter party 510. The order request 570 is communicated to the intended counter party 590 via a separate communications channel 580. In FIG. 4A, it is the intention of the present invention that the order and details 110 are maintained via a semantic relationship database schema.

1. A computer-based system for brokering an ad hoc identification transaction between at least two users on the system, comprising: a personal identification brokering apparatus that includes a communications unit with a minimum of two distinct and separate communications channels, a metabase unit, an order generation unit, a user authentication unit, a transaction authentication unit, and a transaction storage unit; an authentication method that is at least partially based on user-selected criteria and that assigns the system as agent for collecting said information via legal request for information and legal personal information disclosures; an identification transaction order unit that takes into partial consideration authentication requirements for the counter party to the ID transaction from at least one user; an identification transaction order unit that creates a transaction linked to a series of attribute identifiers prescribed by the system and transmitted in at least two parts by the system to at least two user's party to the transaction, with at least one user party to the identification transaction requesting from the other user specific identification attributes regarding the transaction being ordered; a system generated identification transaction order that includes a body of attributes that include a unique purpose for the transaction as selected by at least one user; a method of establishment and use of at least two communications channels to effect the identification transaction; a transaction authentication method based on the near-simultaneous input of the previously transmitted transaction identifiers held by each user party to the transaction creating a closing sequence to the identification transaction ending with the transaction details being recorded, stored, and retrievable on the system.

2. The method of claim 1 where the ID transaction order generation includes at least one user requesting attributes associated with the ad hoc nature of the transaction;

3. The method of claim 1 where the transmittal of the ID order identifier details occurs in separate communications channels in accordance with each user profile resident on the system;

4. The method of claim 1 where the ID transaction order includes specific authentication attribute requirements requested from at least one user to at least one counter party user associated with the ID transaction;

5. The method of claim 1 wherein the communications channels may be the air, a terrestrial communications channel, copper wire or fiber optic wire;

6. The method of claim 5 wherein the medium of communications may be a facsimile, the Internet by means of a GUI, a personal cellular device including pagers, a telephone, an RFID, or a biometric reader device.

7. A component of the personal identification transaction apparatus that includes an identification transaction order generation unit that provides a score associated with each user party to the transaction, as well as the transaction itself;

8. The method of claim 7 whereby the transaction score is partly based on at least one score associated with a user party to the transaction.

9. The method of claim 7 whereby the scoring methodology of the system is bound to each user by means of a contract.
